(19) United States
(12) Patent Application Publication
(10) Pub. No.: US 2026/0067303 A1
(43) Pub. Date: Mar. 5, 2026

(54) ATTACK ANALYSIS DEVICE, ATTACK ANALYSIS METHOD, AND NON-TRANSITORY COMPUTER READABLE MEDIUM

(71) Applicant: Mitsubishi Electric Corporation, Tokyo (JP)

(72) Inventor: Kazuki YONEMOCHI, Tokyo (JP)

(73) Assignee: Mitsubishi Electric Corporation, Tokyo (JP)

(21) Appl. No.: 19/378,863

(22) Filed: Nov. 4, 2025

Related U.S. Application Data
(63) Continuation of application No. PCT/JP2023/023773, filed on Jun. 27, 2023.

(51) Int. Cl. H04L 9/40

(52) U.S. Cl. CPC H04L 63/1416; H04L 63/1491

(57) ABSTRACT

An attack analysis device (100) includes an analysis priority change unit (130) to change an analysis priority corresponding to a target device in accordance with a content of a target attack when the target device is subjected to the target attack being a cyberattack, the target device being a device provided to an attack target system including a plurality of devices each being set with an analysis priority. Assuming that the plurality of devices provided to the attack target system form an attack target device group, when the devices included in the attack target device group are subjected to cyberattacks, the cyberattacks against the devices included in the attack target device group are analyzed in order according to analysis priorities corresponding to the devices included in the attack target device group.

### CROSS REFERENCE TO RELATED APPLICATIONS

This application is a Continuation of PCT International Application No. PCT/JP2023/023773 filed on June 27, 2023, all of which is hereby expressly incorporated by reference into the present application.

### TECHNICAL FIELD

The present disclosure relates to an attack analysis device, an attack analysis method, and an attack analysis program.

### BACKGROUND ART

A honeypot is a system that attracts cyberattacks by making public on the Internet a terminal intentionally configured to be prone to attacks, and observes and analyzes the attracted cyberattacks.

Honeypots typically receive a large amount of attack communications, so it takes time to analyze the received attack communications. Attack communications are communications that indicate cyberattacks. Meanwhile, when a cyberattack that significantly affects a product is observed, it is necessary to quickly analyze the observed cyberattack in order to immediately consider countermeasures.

### Citation List

### Patent Literature

Patent Literature 1: JP2022-191649 A

### SUMMARY OF INVENTION

### Technical Problem

A honeypot simulating a system continuously receives a large amount of cyberattack communications. Also, there is a cyberattack consisting of multiple stages, such as "collecting information and then performing a further cyberattack". Hence, analyzing all cyberattacks in a chronological order would take a lot of time and effort.

Patent Literature 1 discloses a technique for calculating a priority of a cyberattack based on a time-dependent parameter and a non-time-dependent parameter. However, this technology does not use analysis priorities prepared taking into consideration an impact of a cyberattack on a product, nor does it change the analysis priorities according to a content of an observed cyberattack. Therefore, this technology has a problem in that it cannot perform prioritized analysis of a cyberattack against a device that has a high analysis priority.

An objective of the present disclosure is, by using analysis priorities prepared taking into consideration an impact of a cyberattack on a product and by changing the analysis priorities according to a content of an observed cyberattack, to enable the prioritized analysis of a cyberattack against a device that has a high analysis priority.

### Solution to Problem

An attack analysis device according to the present disclosure includes: an analysis priority change unit to change an analysis priority corresponding to a target device in accordance with a content of a target attack when the target device is subjected to the target attack being a cyberattack, the target device being a device provided to an attack target system comprising a plurality of devices each being set with an analysis priority, wherein, assuming that the plurality of devices provided to the attack target system form an attack target device group, when the devices included in the attack target device group are subjected to cyberattacks, the cyberattacks against the devices included in the attack target device group are analyzed in order according to analysis priorities corresponding to the devices included in the attack target device group.

### Advantageous Effects of Invention

According to the present disclosure, an analysis priority change unit changes analysis priorities in accordance with a content of a cyberattack. Here, the analysis priorities may be prepared in consideration of an impact of the cyberattack on a product. Therefore, the present disclosure, by using analysis priorities prepared taking into consideration an impact of a cyberattack on a product and by changing the analysis priorities according to a content of an observed cyberattack, enables prioritized analysis of a cyberattack against a device that has a high analysis priority.

### BRIEF DESCRIPTION OF DRAWINGS

FIG. 1 is a diagram illustrating a configuration example of an attack analysis system 90 according to Embodiment 1.

FIG. 2 is a diagram describing processing of an analysis priority change unit 130 according to Embodiment 1, where (a) illustrates Example 1, and (b) illustrates Example 2.

FIG. 3 is a diagram illustrating a hardware configuration example of an attack analysis device 100 according to Embodiment 1.

FIG. 4 is a flowchart illustrating processing of an asset information creation unit 120 according to Embodiment 1.

FIG. 5 is a diagram indicating specific examples of data stored in an asset DB 191 according to Embodiment 1.

FIG. 6 is a diagram indicating specific examples of data stored in a related information DB 192 according to Embodiment 1.

FIG. 7 is a flowchart illustrating processing of the attack analysis system 90 according to Embodiment 1.

FIG. 8 is a diagram indicating specific examples of data stored in an attack information DB 190 according to Embodiment 1.

FIG. 9 is a diagram describing processing of an analysis priority change unit 130 according to Embodiment 1.

FIG. 10 is a diagram illustrating a hardware configuration example of an attack analysis device 100 according to a modification of Embodiment 1.

FIG. 11 is a diagram illustrating a configuration example of an attack analysis system 90 according to Embodiment 2.

FIG. 12 is a diagram indicating specific examples of data stored in an asset DB 191 according to Embodiment 2.

FIG. 13 is a diagram indicating specific examples of data stored in a vulnerability information DB 193 according to Embodiment 2.

FIG. 14 is a flowchart illustrating processing of the attack analysis system 90 according to Embodiment 2.

FIG. 15 is a diagram indicating specific examples of data stored in an attack information DB 190 according to Embodiment 2.

FIG. 16 is a diagram describing processing of an analysis priority change unit 130 according to Embodiment 2.

### DESCRIPTION OF EMBODIMENTS

In description and drawings of embodiments, the same reference signs are assigned to the same elements and equivalent elements. Explanations of elements with the same reference signs are omitted or simplified as appropriate. Arrows in the diagrams mainly indicate data flows or processing flows. Also, the term "unit" may be interpreted as "circuit", "stage", "procedure", "processing", or "circuitry" as appropriate.

In this specification, a cyberattack may be referred to simply as an "attack".

### Embodiment 1.

From here on, the present embodiment will be described in detail with referring to the drawings.

### *** Description of Configuration ***

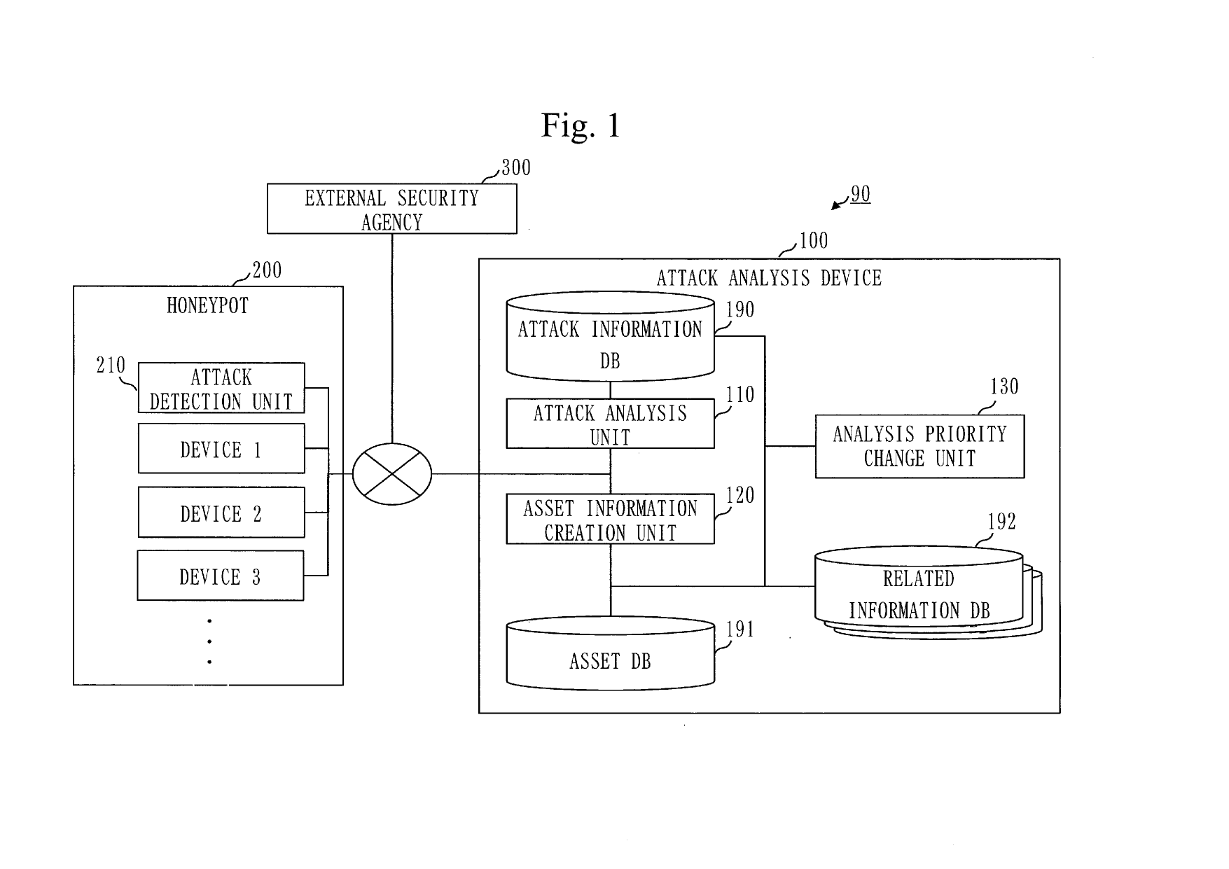

FIG. 1 illustrates a configuration example of an attack analysis system 90 according to the present embodiment. The attack analysis system 90, as illustrated in FIG. 1, is equipped with an attack analysis device 100, a honeypot 200, and an external security agency 300. The elements of the attack analysis system 90 are connected in a way that allows communication via a network.

The attack analysis system 90 uses means to set priority of attack analysis according to an analysis priority that corresponds to each device when an attack is observed in the honeypot 200. In the attack analysis system 90, an attack that consists of multiple stages is effectively analyzed by changing the analysis priority that corresponds to a device that is likely to be attacked in the future based on attack analysis.

As a specific example, consider that a device 1 holds significant information and thus an analysis priority that corresponds to the device 1 is relatively high. In this case, when the device 1 is attacked, the attack on the device 1 is quickly analyzed.

As another specific example, consider that a device 2 does not hold any particularly significant information and thus an analysis priority that corresponds to the device 2 is relatively low. In this case, if the device 2 is attacked, the priority of a countermeasure against the attack on the device 2 is relatively lowered.

As still another specific example, consider a case where if information related to a device 3 has leaked due to an attack, a next attack based on the leaked information may be executed. Therefore, in preparation for the next attack, an analysis priority that corresponds to the device 3 is relatively raised.

The attack analysis device 100, as shown in FIG. 1, includes an attack analysis unit 110, an asset information creation unit 120, and an analysis priority change unit 130. Additionally, the attack analysis device 100 stores an attack information DB (Database) 190, an asset DB 191, and a related information DB 192.

The honeypot 200 is equipped with an attack detection unit 210 and devices. The devices the honeypot 200 is equipped with can be emulators or the like of the devices. The honeypot 200 corresponds to an attack target system. The honeypot 200 may also be a system that corresponds to a product. The term "device" may be interpreted as "terminal". The attack target system includes multiple devices, each of which has an analysis priority that has been set. When the devices included in an attack target device group are subjected to cyberattacks, the cyberattacks against the devices included in the attack target device group are analyzed in order according to analysis priorities corresponding to the devices included in the attack target device group. The attack target device group consists of multiple devices the attack target system is equipped with.

The attack analysis system 90 may include a system that is actually in operation as an attack target system, instead of the honeypot 200. That is, the present embodiment may be utilized as a technology to be used in a security analysis product for a system that is actually in operation.

The attack analysis unit 110 analyzes attacks against the devices the honeypot 200 is equipped with, and stores data indicating results of the analysis as attack information to the attack information DB 190. In this case, the attack analysis unit 110, in a specific example, analyzes a communication log to identify what kind of attack has been made from where and to which terminal. The attack analysis unit 110 may also analyze information stolen by the attack and any anomalies and so on in each device which are caused by the attack.

The asset information creation unit 120 creates the asset DB 191.

When a target device is subjected to a target attack, the analysis priority change unit 130 changes an analysis priority corresponding to the target device in accordance with the content of the target attack. The target device is a device the attack target system is equipped with. The target attack is a cyberattack. When the target device is subjected to the target attack, the analysis priority change unit 130 may change an analysis priority corresponding to the target device in accordance with significance of data stored in the target device. The analysis priority change unit 130 may also change an analysis priority corresponding to each device, among the plurality of devices provided to the attack target system, that will assumedly be subjected to an attack to be executed based on information stolen in the target attack. The stolen information is information that has been accessed without authorization.

As a specific example, the analysis priority change unit 130 looks up the attack information DB 190, the asset DB 191, and the related information DB 192, as needed, to change the analysis priority corresponding to each device. As the amount of attacks on the honeypot 200 is typically immense, the attacks to be analyzed are narrowed down by setting the analysis priority for each device. The number of devices with a relatively high analysis priority may be determined based on the amount of calculation resources, the amount of time that can be spent on attack analysis, and so on.

The attack information DB 190 stores data that represents attack information.

The asset DB 191 stores data that indicates assets. As a specific example, the assets can consist of the devices and the data stored in the devices.

The related information DB 192 stores data that indicates related information. The related information is information that is related to the assets.

The attack detection unit 210 detects attacks against the devices the honeypot 200 is equipped with, and notifies the attack analysis device 100 of the results of the detected attacks.

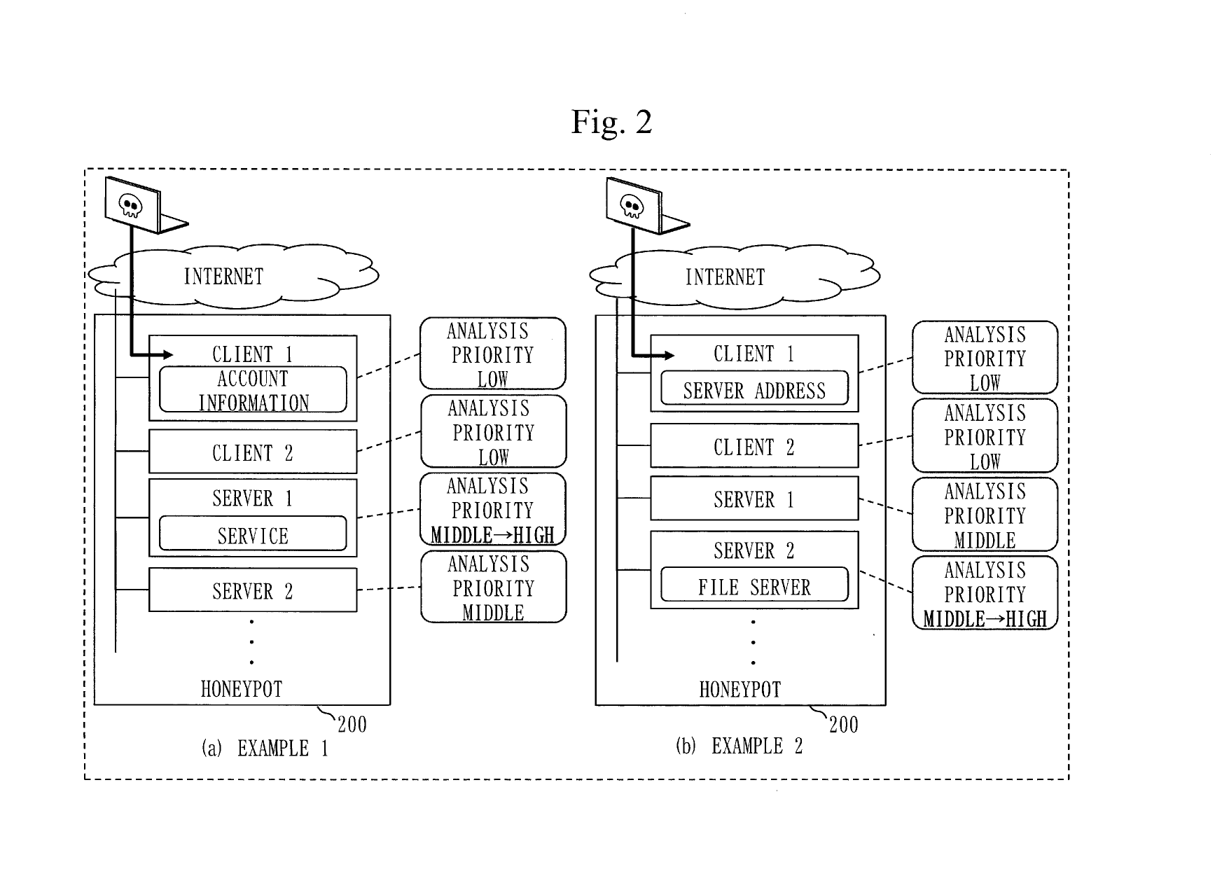

FIG. 2 is a diagram that describes a specific example of processing of the analysis priority change unit 130. Here, each client corresponds to a device, and each server corresponds to a device. Note that before an attack on each device is detected, an analysis priority corresponding to each client is set at "low," and an analysis priority corresponding to each server is set at "medium".

In FIG. 2, (a) shows a specific example in which account information of a service is leaked from a client 1 due to an attack. In this example, the service in question is running on a server 1, so the analysis priority change unit 130 raises an analysis priority for the server 1 because there is a high possibility that unauthorized log-in to the server 1 will be performed in the future.

In FIG. 2, (b) shows a specific example in which address information (path information) of a file server is leaked from the client 1 due to an attack. In this example, the file server in question is running on a server 2, so the analysis priority change unit 130 raises an analysis priority corresponding to the server 2 because there is a high possibility that unauthorized log-in to the server 2 will be performed in the future. When document data has been stolen, the analysis priority change unit 130 may determine that there will be no future attacks based on the stolen document data and may not need to change the analysis priority corresponding to each device.

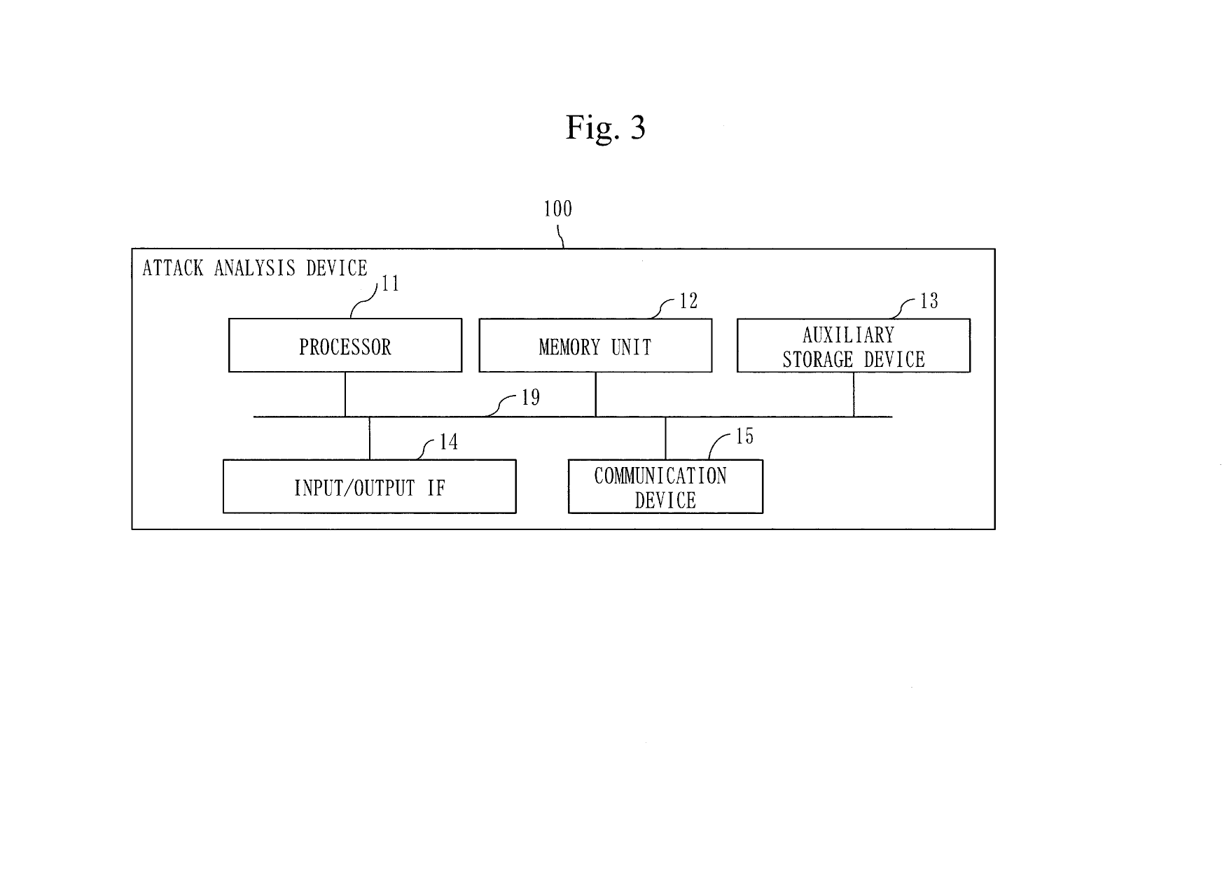

FIG. 3 illustrates a hardware configuration example of the attack analysis device 100 according to the present embodiment. The attack analysis device 100 is composed of a computer. The attack analysis device 100 could be composed of multiple computers.

The attack analysis device 100, as shown in FIG. 3, is a computer equipped with hardware such as a processor 11, a memory unit 12, an auxiliary storage device 13, an input/output IF (Interface) 14, and a communication device 15. These hardware components are appropriately connected via a signal line 19.

The processor 11 is an IC (Integrated Circuit) that performs computational processing and controls the hardware the computer is equipped with. The processor 11, for example, may be a CPU (Central Processing Unit), a DSP (Digital Signal Processor), or a GPU (Graphics Processing Unit).

The attack analysis device 100 may include a plurality of processors as an alternative to the processor 11. These multiple processors can share the role of the processor 11.

The memory unit 12, typically, is a volatile memory device such as, for example, a RAM (Random Access Memory). The memory unit 12 is also referred to as the main storage device or the main memory unit. Data stored in the memory unit 12 is saved in the auxiliary storage device 13 as needed.

The auxiliary storage device 13 is typically a non-volatile memory device such as, for example, a ROM (Read Only Memory), an HDD (Hard Disk Drive), and a flash memory. Data stored in the auxiliary storage device 13 is loaded into the memory unit 12 as necessary.

The memory unit 12 and the auxiliary storage device 13 may be configured integrally.

The input/output IF 14 is a port where input and output devices are connected. The input/output IF 14 is, for example, a USB (Universal Serial Bus) terminal. The input device is, for example, a keyboard-and-mouse. The output device is, for example, a display.

The communication device 15 is a receiver/transmitter. Specifically, the communication device 15 can be a communication chip or an NIC (Network Interface Card).

Each unit in the attack analysis device 100 may suitably use the input/output IF 14 and the communication device 15 when communicating with other devices or the like.

The auxiliary storage device 13 stores an attack analysis program. The attack analysis program is a program that causes the computer to implement the function of each unit provided in the attack analysis device 100. The attack analysis program is loaded to the memory unit 12 and then executed by the processor 11. The function of each unit provided in the attack analysis device 100 is implemented by software.

Data used to execute the attack analysis program, data obtained by executing the attack analysis program, and so on are appropriately stored in a storage device. Each unit in the attack analysis device 100 appropriately utilizes the storage device. As a specific example, the storage device consists of at least one of: the memory unit 12, the auxiliary storage device 13, a register in the processor 11, and a cache memory in the processor 11. It should be noted that the term "data" and the term "information" may sometimes have equivalent meanings. The storage device may be independent of the computer.

The functions of the memory unit 12 and auxiliary storage device 13 may be implemented by another storage device.

The attack analysis program may be stored on a computer-readable non- volatile recording medium. As a specific example, the non-volatile recording medium can be an optical disc or a flash memory. The attack analysis program may be provided as a program product.

### *** Description of Operation ***

An operation procedure of the attack analysis device 100 corresponds to an attack analysis method. Furthermore, a program that realizes the operation of the attack analysis device 100 corresponds to the attack analysis program.

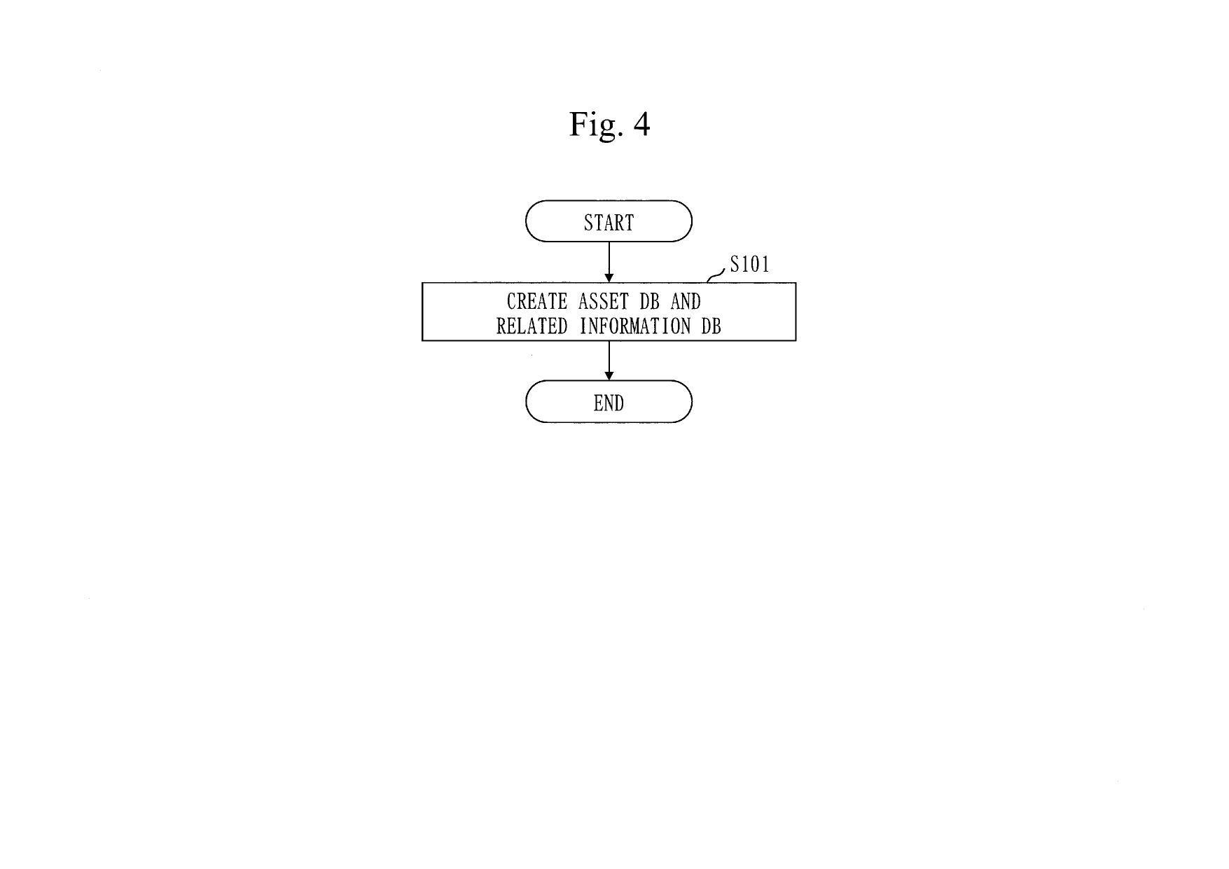

FIG. 4 is a flowchart illustrating an example of processing by the asset information creation unit 120 during preliminary preparation. With referring to FIG. 4, the processing by the asset information creation unit 120 will be described.

### Step S101

The asset information creation unit 120 creates each of the asset DB 191 and the related information DB 192. Depending on the type of information, the asset information creation unit 120 may create multiple DBs as each DB.

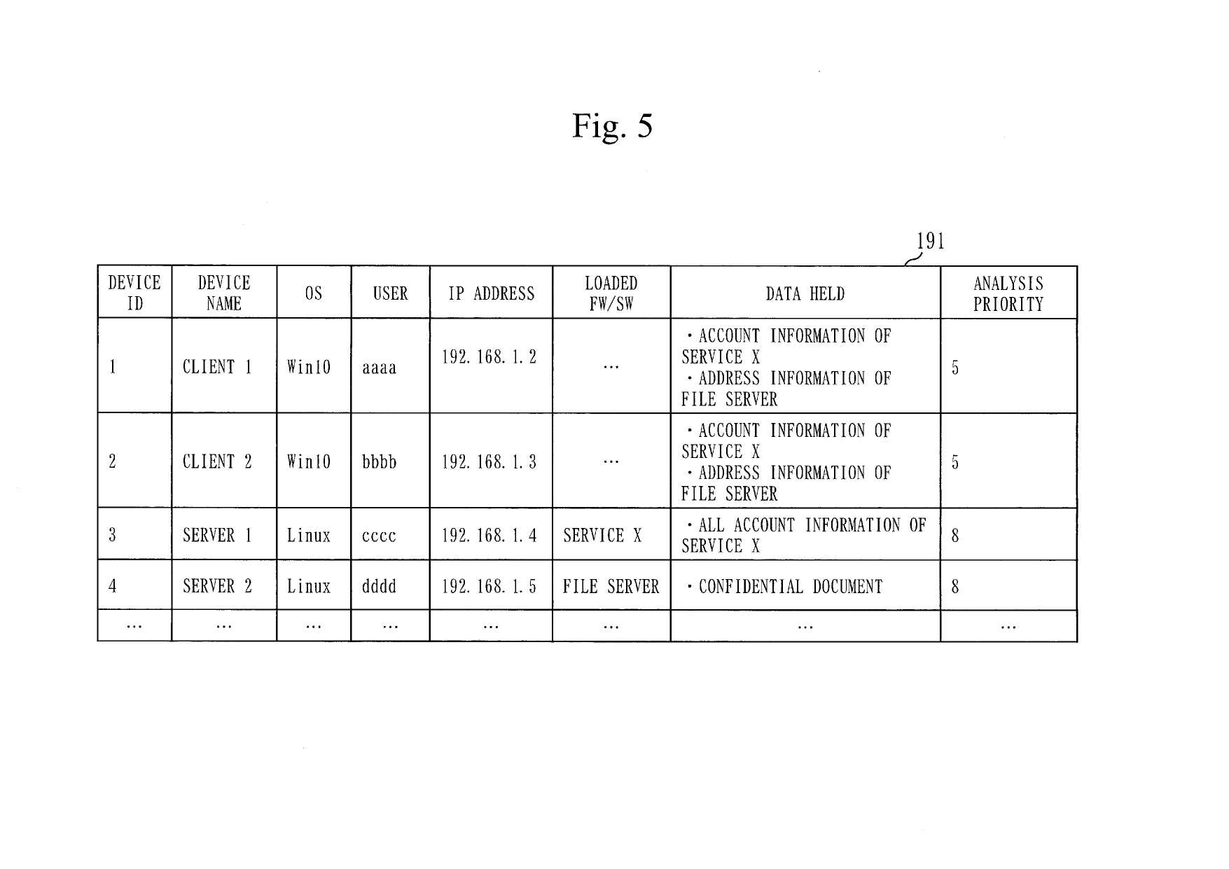

FIG. 5 indicates specific examples of the data stored in the asset DB 191. In this example, asset information consists of information indicating devices, information indicating the configurations of the devices, information indicating the data held by the devices, and information indicating the analysis priorities corresponding to the devices. The asset information creation unit 120 stores the asset information to the asset DB 191. In addition, the asset information creation unit 120 sets analysis priorities that correspond to the devices, and stores to the asset DB 191 the analysis priorities being set. The analysis priorities may be set by an analyst or the like. The analysis priorities may be analysis priorities that have been set considering the impact on the product due to a cyberattack.

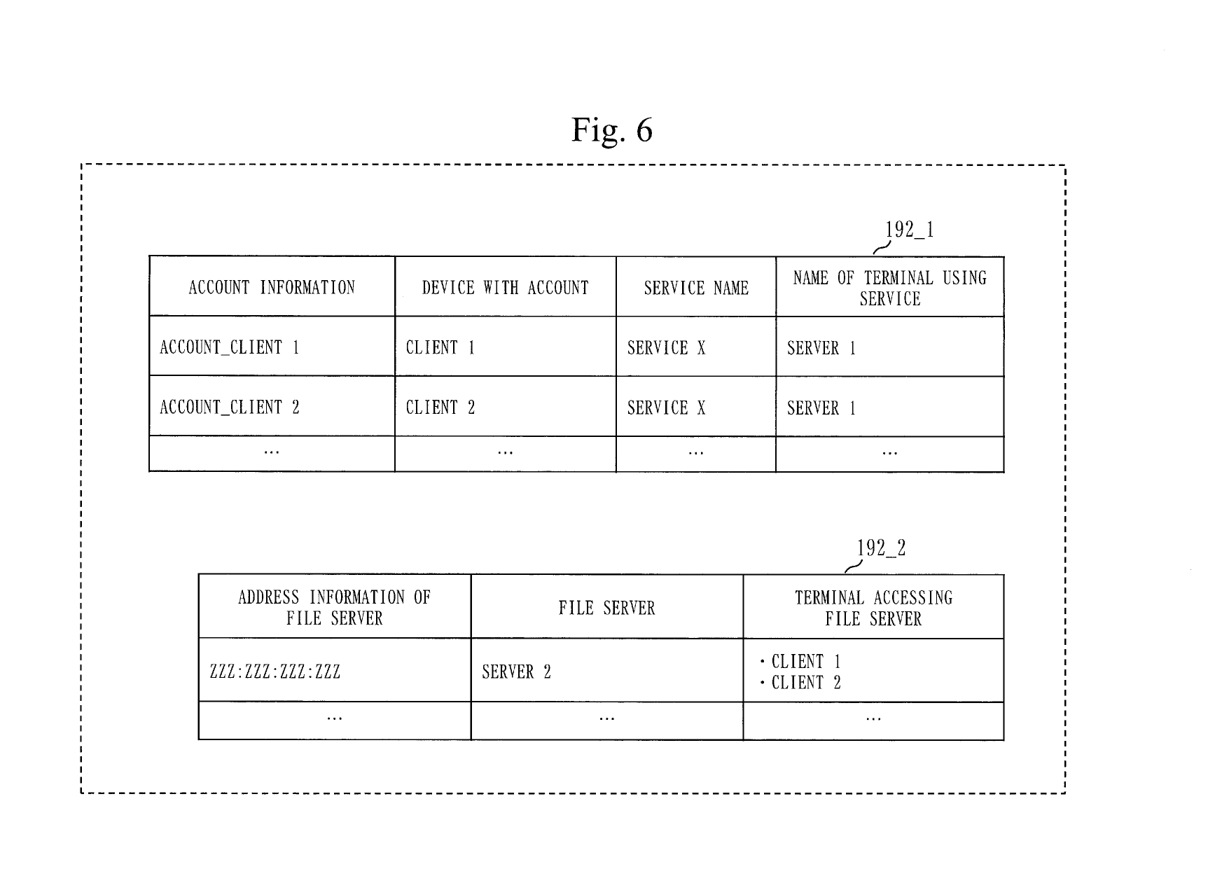

FIG. 6 indicates specific examples of data stored in the related information DB 192. A related information DB 192_1 shows related information of the account information. A related information DB 192_2 shows related information related to the address of the file server.

If the data held by each device is shared with other devices, the asset information creation unit 120 stores information indicating the shared data to the related information DB 192.

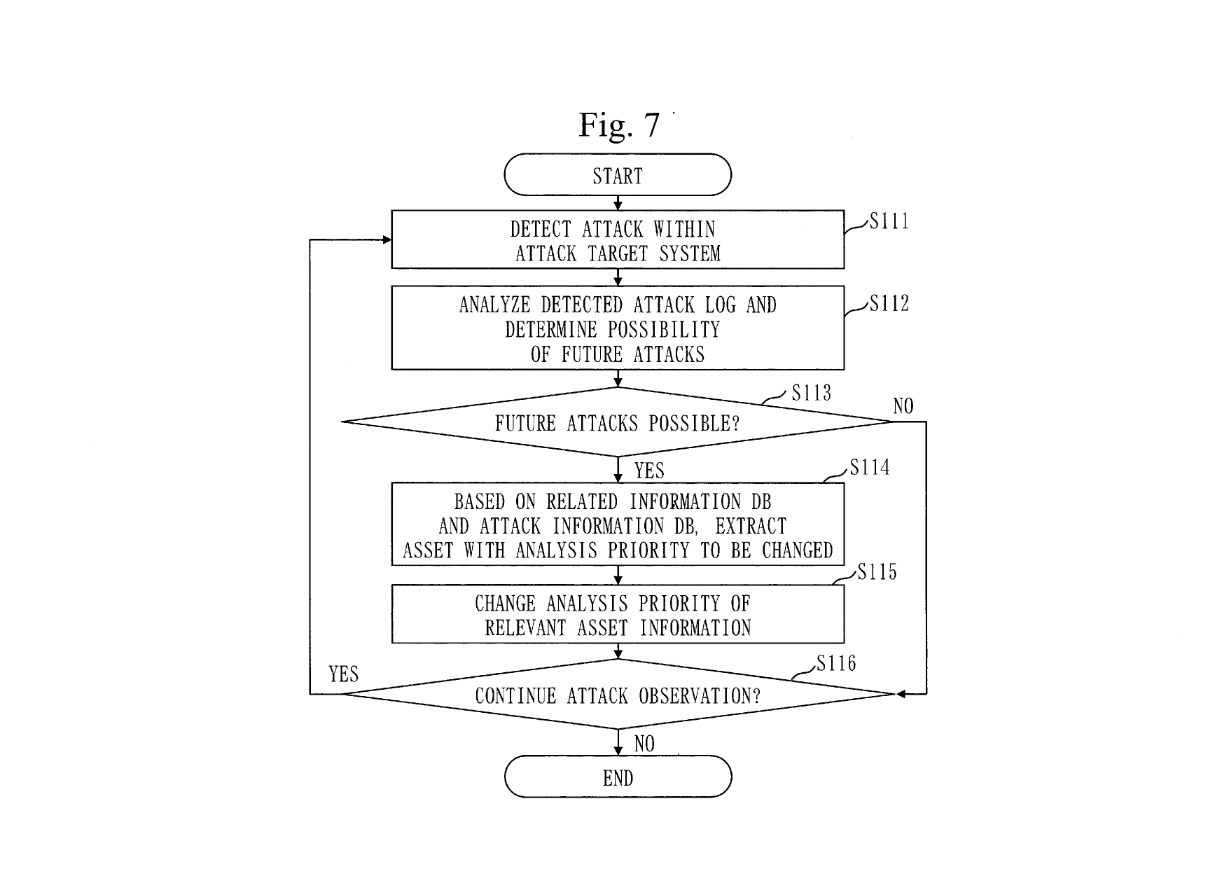

FIG. 7 is a flowchart illustrating an example of processing of the attack analysis system 90 during operation. With referring to FIG. 7, the processing of the attack analysis system 90 will be described.

### Step S111

The attack detection unit 210 detects attacks on the honeypot 200, and sends data indicating the detected attacks to the attack analysis device 100.

### Step S112

The attack analysis unit 110 receives from the honeypot 200 data indicating the attacks, and by analyzing the log of each attack indicated by the received data, identifies data that has been accessed unauthorizedly by each attack, and stores data indicating the identified data to the attack information DB 190.

Subsequently, the attack analysis unit 110, based on the asset information stored in the asset DB 191 and corresponding to an unauthorized access destination in each attack, the attack information from the external security agency 300, and so on, determines whether there may be a possibility of an attack in the future. The attack analysis unit 110 stores data indicating the results of the determination to the attack information DB 190.

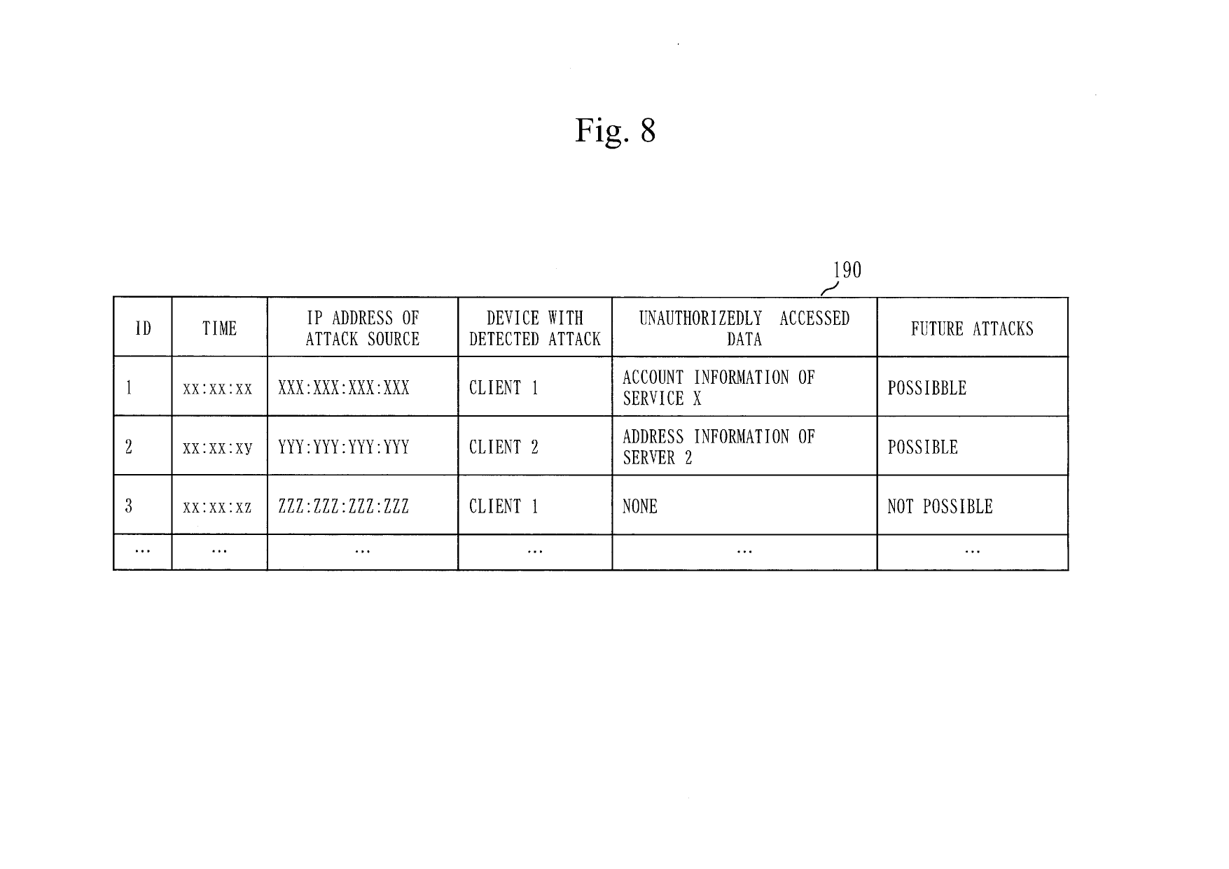

FIG. 8 indicates specific examples of data stored in the attack information DB 190. The data shows, for each attack, the device that was attacked, the data that was accessed unauthorizedly, and the possibility of the attack in the future.

Note that in the asset DB 191, whether or not there will be a possibility of an attack in the future may be set in advance for each piece of information. As a specific example, in the asset DB 191, information indicating that there is a possibility of an attack in the future for the information showing the account is set. At this time, when there is an unauthorized access to information showing the account, the attack analysis unit 110 determines that there is a possibility of an attack in the future on a device corresponding to the information showing the account.

### Step S113

If there is an attack being set in the attack information DB 190 as possible in the future, step S114 is executed next. Otherwise, step S116 is executed next.

### Step S114

The analysis priority change unit 130 extracts, from the related information DB 192, another device sharing data unauthorizedly accessed by the attack being set in the attack information DB 190 to possibly occur in the future. FIG. 8 shows that the attacks being set in the attack information DB 190 to possibly occur in the future are an unauthorized access to account information of a service X and an unauthorized access to address information of the server 2.

As a specific example, the account information of the service X for a client 1 shown in FIG. 8 is data used in the server 1, as shown in the related information DB 192_1. Therefore, the analysis priority change unit 130 determines that there is a possibility that the server 1 will be attacked in the future.

As another specific example, the address information of the server 2 shown in FIG. 8 is data used to access the file server within the server 2, as shown in the related information DB 192_2. Therefore, the analysis priority change unit 130 determines that there is a possibility that the server 2 will be attacked in the future.

### Step S115

The analysis priority change unit 130 changes as necessary the analysis priority corresponding to a device subjected to each attack being set in the attack information DB 190 to possibly occur in the future, and the analysis priority corresponding to each device extracted from the related information DB 192 in step S114.

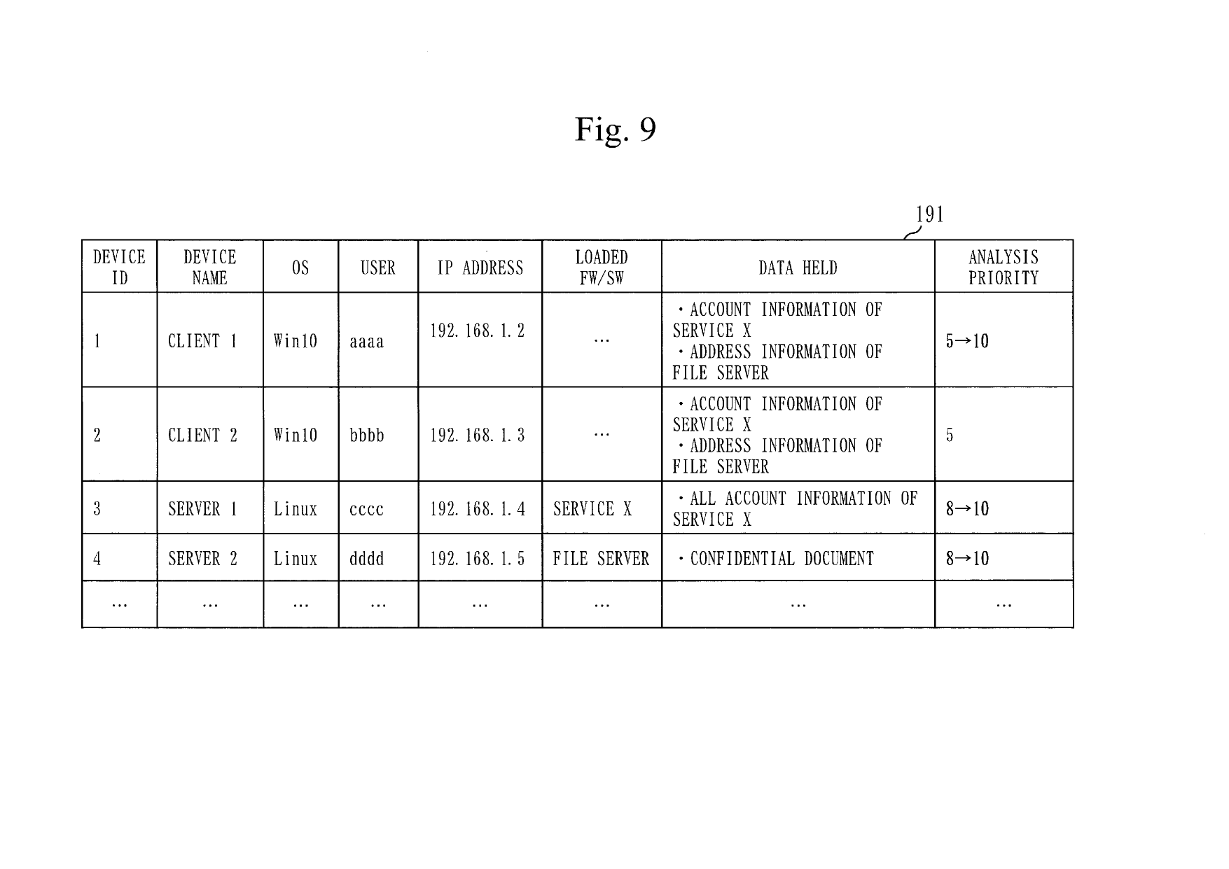

FIG. 9 is a diagram corresponding to FIG. 5, FIG. 6 and FIG. 8, and describes specific examples of processing to change the analysis priority.

As a specific example, the client 1 corresponds to the device subjected to an attack being set in the attack information DB 190 to possibly occur in the future. Therefore, the analysis priority change unit 130 raises the analysis priority corresponding to the client 1. In addition, the server 1 operates the service X that uses the account information leaked due to the attack on the client 1. Therefore, the analysis priority change unit 130 raises the analysis priority corresponding to the server 1.

As still another specific example, the analysis priority change unit 130 raises the analysis priority corresponding to the client 1 that has been unauthorizedly accessed, and the analysis priority corresponding to the server 2 that can be accessed using the address information leaked due to the attack on the client 1.

### Step S116

If the attack analysis system 90 continues attack observation, step S111 is executed again. Otherwise, the attack analysis system 90 ends the processing of this flowchart.

Additionally, the analysis priority change unit 130 may change the analysis priority as needed. For instance, if the risk of a possible attack in the future on a certain device is decreased due to implementation of countermeasures to the certain device, the analysis priority change unit 130 changes the analysis priority corresponding to the certain device back to its original value.

### *** Description of Effect of Embodiment 1 ***

According to the present embodiment, it is possible to use an analysis priority that has been set in accordance with the asset content and to change the analysis priority in accordance with the attack content. By setting an analysis priority corresponding to each device that is the attack analysis target, the task of analyzing the attack can be made more efficient. Also, by changing the analysis priority in accordance with the attack content, it is possible to determine the analysis priority and the countermeasure priority in accordance with the attack situation.

By utilizing the present embodiment, it is possible to prioritize analysis of an attack on a device with a comparatively high analysis priority, among the multiple attacks observed.

Further, according to the present embodiment, if a device likely to be targeted in a future attack is revealed based on an observed attack, it is possible to change the analysis priority corresponding to the device likely to be targeted. Therefore, according to the present embodiment, it is possible to cope with an attack consisting of multiple stages, such as performing one attack and after that performing another attack by using the former attack as a foothold. As a specific example, with respect to an attack consisting of multiple stages, such as "collecting information and then performing a further attack", at a stage at which it is detected that information is collected, an analysis priority corresponding to a device that may be targeted in a next-stage attack is raised, so when the device is hit by the next-stage attack, the attack on that device can be analyzed quickly.

### *** Other Configurations ***

### Modification 1

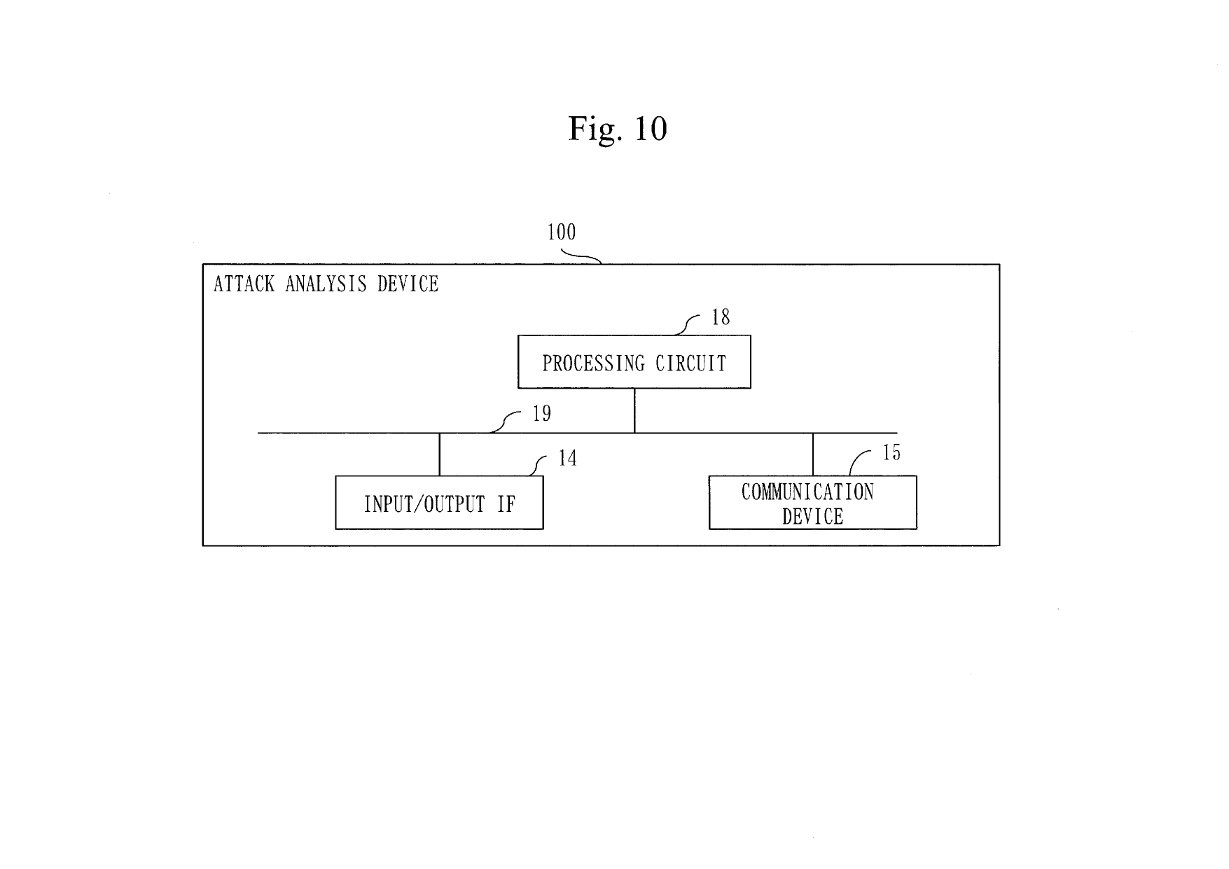

FIG. 10 illustrates a hardware configuration example of an attack analysis device 100 according to the present modification.

The attack analysis device 100 includes a processing circuit 18 instead of: a processor 11; a processor 11 and a memory unit 12; a processor 11 and an auxiliary storage device 13; or a processor 11, a memory unit 12, and an auxiliary storage device 13.

The processing circuit 18 is hardware that implements at least some of units provided in the attack analysis device 100.

The processing circuit 18 may be dedicated hardware, or a processor that executes a program stored in the memory unit 12.

When the processing circuit 18 is dedicated hardware, the processing circuit 18, for instance, is a single circuit, a composite circuit, a programmed processor, a parallel-programmed processor, an ASIC (Application Specific Integrated Circuit), an FPGA (Field Programmable Gate Array), or a combination of these.

As an alternative to the processing circuit 18, the attack analysis device 100 may include a plurality of processing circuits. The plurality of processing circuits share the role of the processing circuit 18.

In the attack analysis device 100, some functions may be implemented by dedicated hardware, and the remaining functions may be implemented by software or firmware.

The processing circuit 18 is implemented, as a specific example, by hardware, software, firmware, or a combination of these.

The processor 11, the memory unit 12, the auxiliary storage device 13, and the processing circuit 18 are collectively referred to as "processing circuitry". In other words, the functions of the functional components of the attack analysis device 100 are implemented by processing circuitry.

An attack analysis device 100 according to another embodiment may also have a configuration similar to that of the present modification.

### Embodiment 2.

Below, the aspects that differ from the aforementioned embodiment will mainly be described with reference to drawings.

### *** Description of Configuration ***

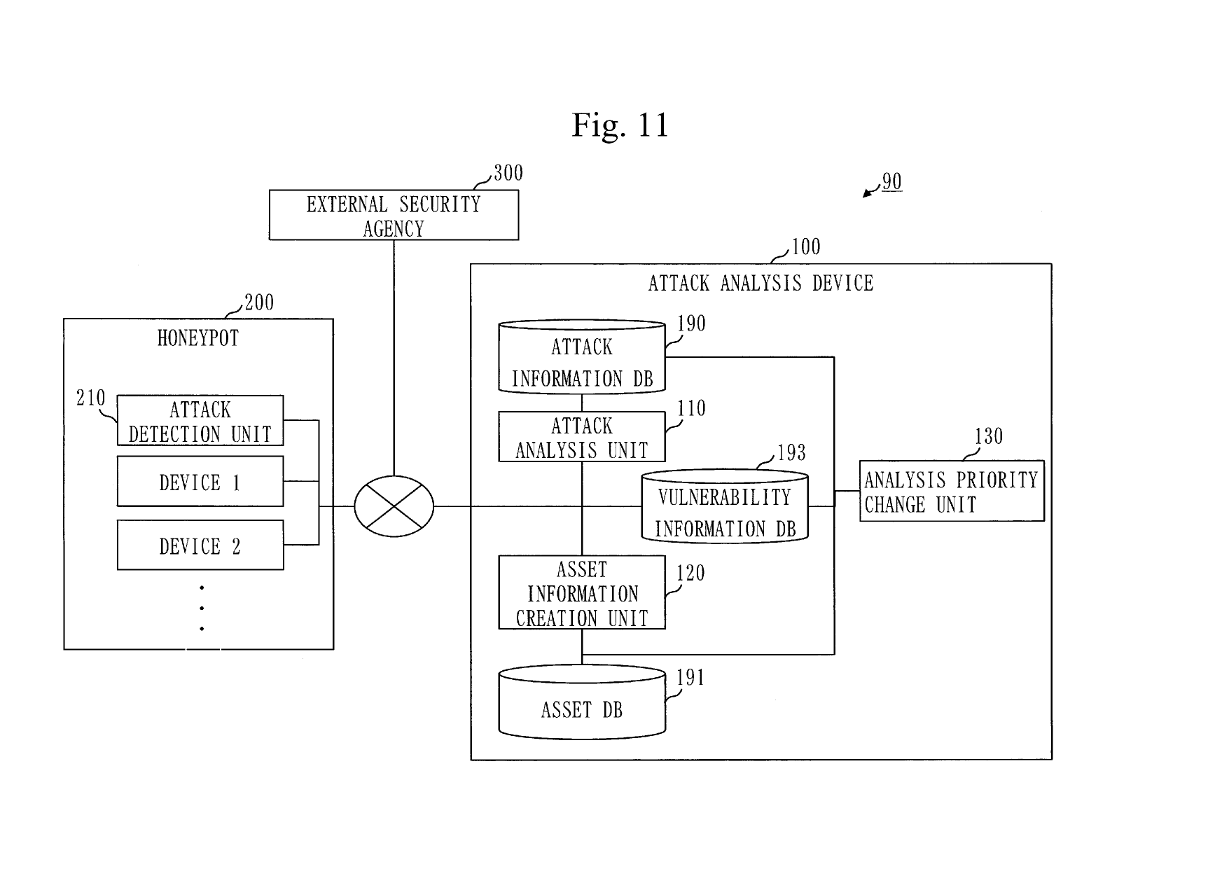

FIG. 11 illustrates a configuration example of an attack analysis system 90 according to the present embodiment. An attack analysis device 100 according to the present embodiment further stores a vulnerability information DB 193 as shown in FIG. 11. The attack analysis device 100 may store a related information DB 192.

The attack analysis device 100 according to the present embodiment has a function to change the analysis priority of another device with the same vulnerability when each device in the honeypot 200 is exploited for its vulnerability and is attacked. As a specific example, when an attack exploiting the vulnerability of software a installed in the client 1 is detected, it is considered that a client 2 loaded with the same software a will likely be attacked in the future, so the analysis priority corresponding to the client 2 is raised.

When a target attack is caused by a target vulnerability, an analysis priority change unit 130 according to the present embodiment changes an analysis priority corresponding to each device having the target vulnerability, among a plurality of devices provided to an attack target system and other than the target device. The target vulnerability is a vulnerability the target device has.

The vulnerability information DB 193 stores information indicating the vulnerability of device, software, and so on.

### *** Description of Operation ***

The following describes the differences in processing of an asset information creation unit 120 during preliminary preparations, from that of Embodiment 1.

### (Step S101)

In addition to a process of step S101 according to Embodiment 1, the asset information creation unit 120 executes the following processing.

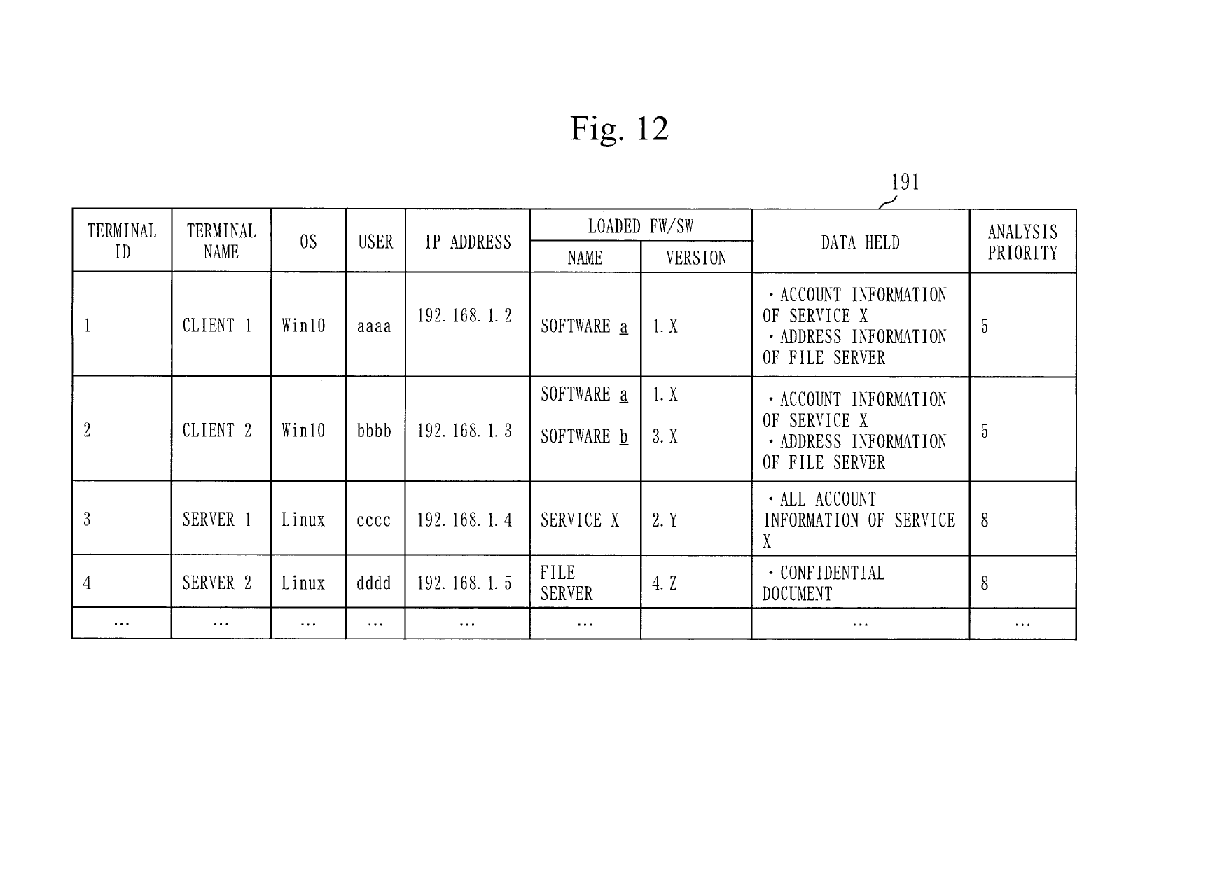

The asset information creation unit 120 stores, to the asset DB 191, information indicating versions of each FW (firmware) and versions of each SW (software) which are installed on each device, in addition to the asset information. FIG. 12 indicates specific examples of data stored in an asset DB 191.

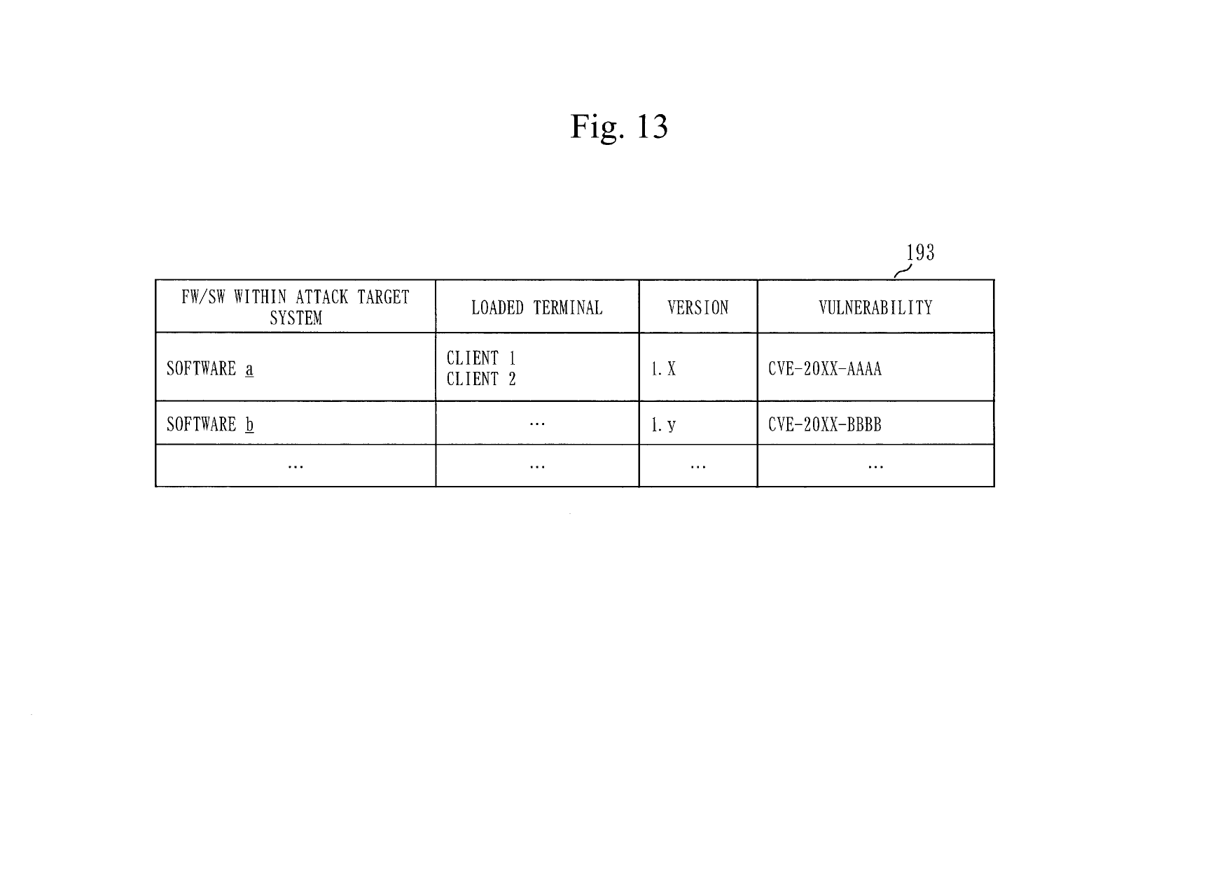

Furthermore, the asset information creation unit 120 creates the vulnerability information DB 193 based on information from an external security agency 300. FIG. 13 indicates specific examples of data stored in the vulnerability information DB 193. The data shows the vulnerabilities of the FWs and the SWs by version which are installed on each device.

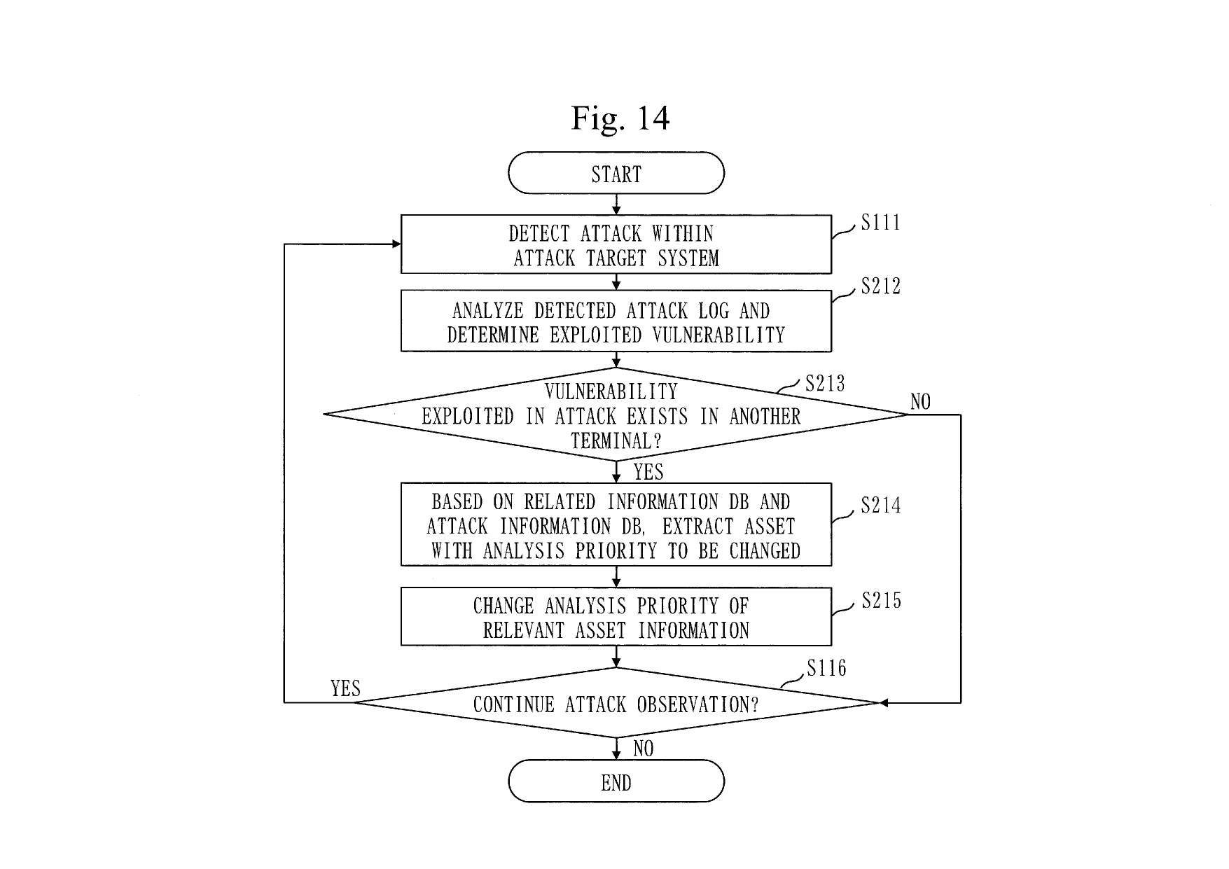

FIG. 14 is a flowchart illustrating an example of processing of the attack analysis system 90 during operation. Referring to FIG. 14, the processing of the attack analysis system 90 will be described. Additionally, the attack analysis system 90 may execute the following processing in addition to the processing of the attack analysis system 90 according to Embodiment 1.

### Step S212

An attack analysis unit 110 receives from the honeypot 200 data indicating the attacks, and by analyzing the log of each attack indicated by the received data, identifies data that has been accessed unauthorizedly by each attack access, and stores data indicating the identified data to an attack information DB 190.

Subsequently, the attack analysis unit 110, based on asset information stored in the asset DB 191 and corresponding to an unauthorized access destination in each attack, attack information from the external security agency 300, and so on, determines a vulnerability exploited in each attack. The attack analysis unit 110 stores data indicating the results of the determination to the attack information DB 190.

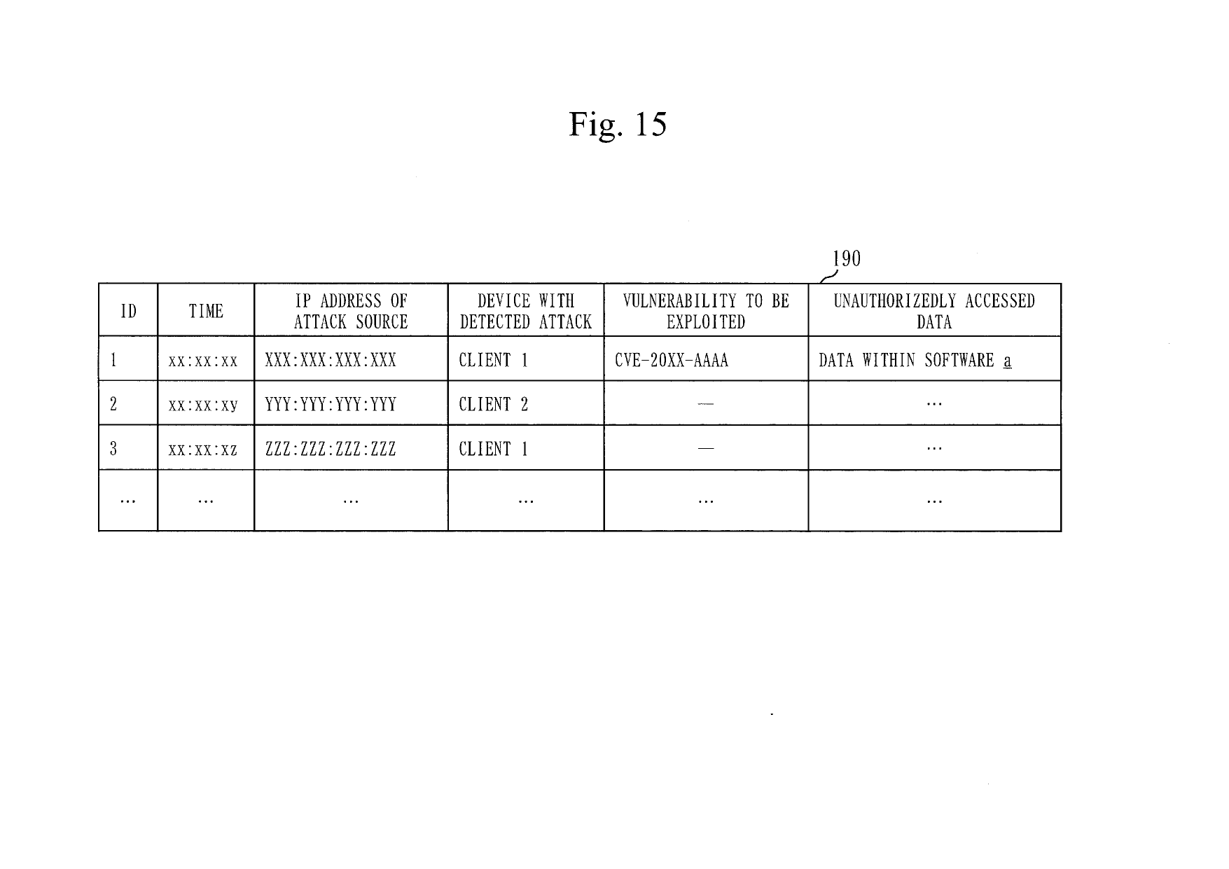

FIG. 15 indicates specific examples of data stored in the attack information DB 190.

### Step S213

The analysis priority change unit 130 refers to the attack information DB 190 and the vulnerability information DB 193 to determine whether a vulnerability determined by the attack analysis unit 110 exists in another device as well.

If the vulnerability is determined to exist in another device, step S214 is executed next. Otherwise, step S116 is executed next.

### Step S214

The analysis priority change unit 130 refers to the attack information DB 190 and the vulnerability information DB 193, and extracts another device with the vulnerability determined by the attack analysis unit 110, as a related device.

For instance, as shown in FIG. 13 and FIG. 15, software a loaded in the client 1 was exploited for its vulnerability and was unauthorizedly accessed. Moreover, software a, being an identical version as the version loaded in the client 1, is also loaded in the client 2. Therefore, the analysis priority change unit 130 determines that in future, the client 2 might be subjected to a similar attack as the attack to the client 1, and extracts the client 2 as a related device.

### Step S215

The analysis priority change unit 130 changes as necessary the analysis priority corresponding to each related device extracted in step S214.

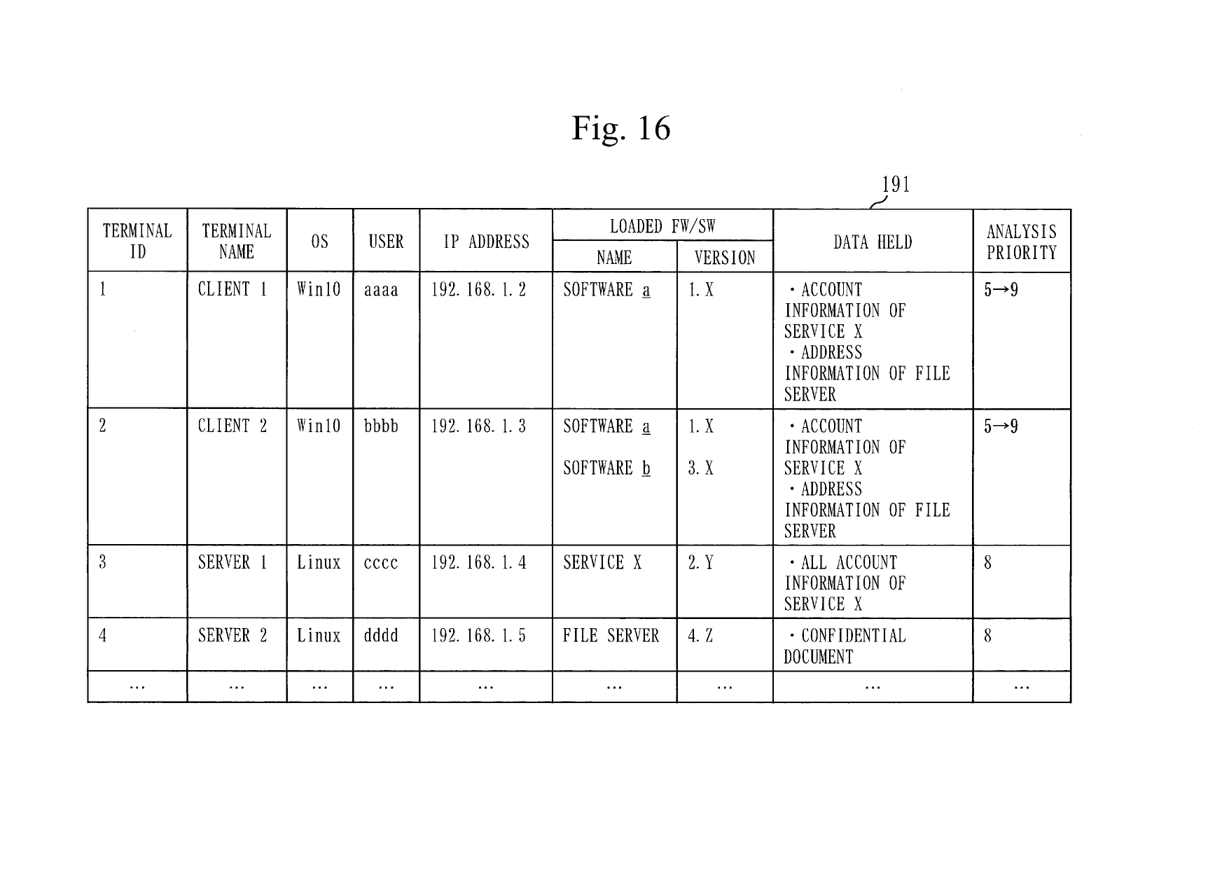

FIG. 16 is a diagram corresponding to FIG. 12, FIG. 13, and FIG. 15, and describes specific examples of processing to change the analysis priority. In this example, the analysis priority change unit 130 raises an analysis priority corresponding to the client 1 that has been unauthorizedly accessed, and the analysis priority corresponding to the client 2 that has the same vulnerability as the vulnerability of the client 1 that has been unauthorizedly accessed.

### *** Description of Effect of Embodiment 2 ***

According to the present embodiment, the analysis priority corresponding to each device with the same vulnerability as the vulnerability of the target device that was attacked can be raised before an attack on that device is observed.

### *** Other Embodiments ***

The aforementioned embodiments can be combined freely; an arbitrary constituent component of each embodiment can be modified; or an arbitrary constituent component in each embodiment can be omitted.

Also, the embodiments are not limited to those shown in Embodiments 1 to 2, and various changes can be made as needed. The procedures described using flowcharts, etc., may be appropriately altered.

### REFERENCE SIGNS LIST

11: processor; 12: memory unit; 13: auxiliary storage device; 14: input/output IF; 15: communication device; 18: processing circuit; 19: signal line; 90: attack analysis system; 100: attack analysis device; 110: attack analysis unit; 120: asset information creation unit; 130: analysis priority change unit; 190: attack information DB; 191: asset

DB; 192: related information DB; 193: vulnerability information DB; 200: honeypot; 210: attack detection unit; 300: external security agency.

1. An attack analysis device comprising
processing circuitry
to change an analysis priority corresponding to a target device in accordance with a content of a target attack when the target device is subjected to the target attack being a cyberattack, the target device being a device provided to an attack target system comprising a plurality of devices each being set with an analysis priority,
wherein, assuming that the plurality of devices provided to the attack target system form an attack target device group, when the devices included in the attack target device group are subjected to cyberattacks, the cyberattacks against the devices included in the attack target device group are analyzed in order according to analysis priorities corresponding to the devices included in the attack target device group,
wherein the analysis priorities corresponding to the devices included in the attack target device group have been set according to an impact on the attack target system caused by the cyberattacks against the devices included in the attack target device group, and
wherein, when the target device is subjected to the cyberattack, the processing circuitry changes an analysis priority corresponding to each device that is likely to be subjected to a cyberattack due to a leak of information held by the target device, among the devices included in the attack target device group and other than the target device.

2. The attack analysis device according to claim 1, wherein when the target attack is caused by a target vulnerability being a vulnerability the target device has, the processing circuitry changes an analysis priority corresponding to each device having the target vulnerability, among the plurality of devices provided to the attack target system and other than the target device.

3. The attack analysis device according to claim 1, wherein the attack target system is a honeypot.

4. The attack analysis device according to claim 2, wherein the attack target system is a honeypot.

5. An attack analysis method comprising:
changing an analysis priority corresponding to a target device in accordance with a content of a target attack when the target device is subjected to the target attack being a cyberattack, the target device being a device provided to an attack target system comprising a plurality of devices each being set with an analysis priority, wherein, assuming that the plurality of devices provided to the attack target system form an attack target device group, when the devices included in the attack target device group are subjected to cyberattacks, the cyberattacks against the devices included in the attack target device group are analyzed in order according to analysis priorities corresponding to the devices included in the attack target device group,
wherein the analysis priorities corresponding to the devices included in the attack target device group have been set according to an impact on the attack target system caused by the cyberattacks against the devices included in the attack target device group, and
wherein the attack analysis method comprises, when the target device is subjected to the cyberattack, changing an analysis priority corresponding to each device that is likely to be subjected to a cyberattack due to a leak of information held by the target device, among the devices included in the attack target device group and other than the target device.

6. A non-transitory computer readable medium recorded with an attack analysis program which causes an attack analysis device being a computer, to execute an analysis priority change process of changing an analysis priority corresponding to a target device in accordance with a content of a target attack when the target device is subjected to the target attack being a cyberattack, the target device being a device provided to an attack target system comprising a plurality of devices each being set with an analysis priority,
wherein, assuming that the plurality of devices provided to the attack target system form an attack target device group, when the devices included in the attack target device group are subjected to cyberattacks, the cyberattacks against the devices included in the attack target device group are analyzed in order according to analysis priorities corresponding to the devices included in the attack target device group,
wherein the analysis priorities corresponding to the devices included in the attack target device group have been set according to an impact on the attack target system caused by the cyberattacks against the devices included in the attack target device group, and
wherein the analysis priority change process comprises, when the target device is subjected to the cyberattack, changing an analysis priority corresponding to each device that is likely to be subjected to a cyberattack due to a leak of information held by the target device, among the devices included in the attack target device group and other than the target device.
